(19) United States
(12) Patent Application Publication
(10) Pub. No.: US 2026/0284816 A1
(43) Pub. Date: Sep. 24, 2026

(54) COLLECTING CONTAINER FOR WORKPIECE PARTICLES, ASSEMBLY COMPRISING A MOTOR-DRIVEN HANDHELD TOOL AND A COLLECTING CONTAINER, AND HANDHELD TOOL SYSTEM

(71) Applicant: Festool GmbH, Wendlingen (DE)

(72) Inventor: Johannes Rau, Plochingen (DE)

(73) Assignee: Festool GmbH, Wendlingen (DE)

(21) Appl. No.: 19/478,477

(22) PCT Filed: Apr. 24, 2024
(86) PCT No.: PCT/EP2024/061288

§ 371 Date: Oct. 24, 2025

(30) Foreign Application Priority Data
Apr. 26, 2023 (DE) 10 2023 110 818.2

(51) Int. Cl. B23Q 11/00

(52) U.S. Cl. CPC B23Q 11/0071

(57) ABSTRACT

A collecting container (18) for workpiece particles is described, which is designed for coupling to a motor-driven hand-held tool (16). The collecting container (18) comprises a container body (22), which is delimited by an outer skin (32). The container body (22) comprises a folding mechanism (31) so that it can selectively assume a work position, in which the outer skin (32) encloses a first volume (V1), and selectively assume a transport position, in which the outer skin (32) encloses a second volume (V2). The second volume (V2) is smaller than the first volume. In addition, a first outer skin longitudinal dimension (Lmax) has a greatest length in comparison to the remaining outer skin longitudinal dimensions in the work position. The first outer skin longitudinal dimension (Lmax) defines a greatest length of the container body (22) in the transport position. In addition, an assembly (14) is proposed comprising a motor-driven hand-held tool (16) and such a collecting container (18). Furthermore, a hand-held tool system having such an assembly (14) and a storage container is presented.

The invention relates to a collecting container for workpiece particles, which is designed for coupling to a motor-driven hand-held tool. The collecting container comprises a container body, which is delimited by an outer skin. The container body comprises a folding mechanism so that the container body can selectively assume a work position, in which the outer skin encloses a first volume, and selectively assume a transport position, in which the outer skin encloses a second volume. The second volume is smaller than the first volume.

The invention also relates to an assembly, which comprises a motor-driven hand-held device and such a collecting container.

In addition, the invention relates to a hand-held tool system having such an assembly and a storage container.

Such hand-held tool systems, assemblies and collecting containers are known from the prior art. In this context, the outer skin of the container body is usually made of a material that is permeable to air, but retains workpiece particles above a predetermined particle size. In other words, the outer skin functions as a filter to separate workpiece particles from air. A mixture of air and workpiece particles resulting from material processing carried out by means of the associated hand-held tool can thus be fed into the collecting container. The workpiece particles are retained in the collecting container so that material processing only causes comparatively little contamination.

In order to be able to accommodate as large a quantity of workpiece particles as possible and thus only rarely have to empty the collecting container, the largest possible volume of the container body is desirable in the work position. In other words, the first volume should be large. Furthermore, the aim is for the outer skin to have as large a surface area as possible in the work position. This is conducive to the aforementioned filter function. In addition, a mixture of air and workpiece particles flowing into the collecting container has to be slowed down within the collecting container. This can be achieved particularly effectively if a dimension of the container body is as large as possible along an associated main flow direction.

In contrast, the aim for the transport position is always for the container body to have the smallest possible volume. In other words, the second volume should be as small as possible.

The collecting container is faced with conflicting requirements for the work position and transport position.

It is therefore the object of the invention to create a collecting container that resolves or at least alleviates this conflict of requirements. A collecting container should therefore be created which has a comparatively large volume in the work position and is as compact as possible in the transport position.

The object is achieved by a collecting container for workpiece particles, which is designed for coupling to a motor-driven hand-held tool. The collecting container comprises a container body, which is delimited by an outer skin. The container body comprises a folding mechanism so that the container body can selectively assume a work position, in which the outer skin encloses a first volume, and selectively assume a transport position, in which the outer skin encloses a second volume. The second volume is smaller than the first volume. A first outer skin longitudinal dimension has a greatest length in comparison to the remaining outer skin longitudinal dimensions in the work position. The first outer skin longitudinal dimension defines a greatest length of the container body in the transport position. An outer skin longitudinal dimension is to be understood in this context as a longitudinal dimension of the outer skin. An orientation of the longitudinal dimension in space is irrelevant. Depending on the spatial orientation of the container body, an outer skin longitudinal dimension can thus be a length, a width or a height. Furthermore, an outer skin longitudinal dimension can be defined between any pairs of surfaces, edges and corners of the outer skin. Dimensions of surfaces and edges of the outer skin also come under the term outer skin longitudinal dimension. By way of example, an outer skin longitudinal dimension extends along an edge of the outer skin. The collecting container according to the invention is consequently characterised in that a greatest length of the container body in the transport position is defined by that outer skin longitudinal dimension that has the greatest length in the work position. In other words, the container body can be folded by means of the folding mechanism in such a way that the greatest outer skin longitudinal dimension in the work position, which does not necessarily also have to be the greatest overall dimension of the container body, becomes the greatest overall dimension of the container body in the transport position. The container body thus does not become longer in any respect as a result of folding. This results in a good compromise between the container body having as large a volume as possible in the work position and the container body having as small a volume as possible in the transport position. Ideally, the volume is zero in the transport position.

The fact that in the collecting container according to the invention, the first outer skin longitudinal dimension defines a greatest length of the container body in the transport position means in this case that the first outer skin longitudinal dimension determines or establishes the greatest length of the container body in the transport position. In particular, only the first outer skin longitudinal dimension defines the greatest length of the container body in the transport position. The first outer skin longitudinal dimension thus alone determines the greatest length of the container body in the transport position or alone establishes the greatest length of the container body in the transport position. The greatest length of the container body in the transport position can substantially correspond to the first outer skin longitudinal dimension. The greatest length of the container body in the transport position and the first outer skin longitudinal dimension can thus be substantially the same. Alternatively, the greatest length of the container body in the transport position and the first outer skin longitudinal dimension can be different, wherein, however, the first outer skin longitudinal dimension always defines, i.e. determines or establishes, a greatest length of the container body in the transport position. In other words, the greatest length of the container body in the transport position is a function of the first outer skin longitudinal dimension or at least dependent on the first outer skin longitudinal dimension.

In one example, the container body has a filling volume greater than 0.8 litres in the work position.

Depending on the specific application, the workpiece particles are also referred to as dust, for example grinding dust, or chips, for example sawdust.

In one embodiment, the container body comprises a support structure formed from struts hingedly connected to one another. The outer skin is then formed by a covering surrounding the support structure. Such a container body can be easily moved from the work position to the transport position and vice versa. The container body is mechanically stable in both positions. Furthermore, a support structure formed from struts hingedly connected to one another can be folded in a compact manner. In this context, the joints, which connect the struts to one another, form the folding mechanism.

At least two struts can be C-shaped at least in sections and hingedly connected to one another. Alternatively, the struts can form at least two strut assemblies which are respectively C-shaped at least in sections. The at least two struts which are C-shaped at least in sections or the two strut assemblies which are C-shaped at least in sections can be rotated relative to one another in a fan-like manner. In the work position, the two C-shaped struts or two C-shaped strut assemblies can consequently be spread out like a fan in order to create a comparatively large volume of the container body. In the transport position, the two C-shaped struts or two C-shaped strut assemblies can be substantially placed on top of one another such that the container body is compact in the transport position.

In this context, both the C-shaped struts and C-shaped strut assemblies respectively have joint elements at their ends. Within a C-shaped strut and within a C-shaped strut assembly, the joint elements respectively arranged at the ends have a common joint axis. In a container body which comprises at least two C-shaped struts or at least two C-shaped strut assemblies, the joint axes of adjacent struts or strut assemblies are close to one another or coincide.

In one embodiment, the struts form a cross frame. At least two struts are thus rotatably attached to one another via their respective central sections. In this way, it is possible that the at least two struts assume a relative position in the work position in which they cross as viewed along the axis of rotation. In the transport position, the struts can be substantially placed on top of one another by virtue of their rotatable attachment to one another. This easily results in the container body having a large volume when it is in the work position, and a small volume when the container body is in the transport position.

The support structure can also be poly gonal in a lateral view in relation to a main flow direction. The main flow direction runs from an outer skin surface, which comprises an inlet for the mixture of air and workpiece particles, in the direction of an outer skin surface opposite it. A comparatively large volume can be spanned in the work position by means of a polygonal support structure.

In this context, the polygon shape can comprise four or five polygon corners, which are respectively formed by hinged connections of struts. The hinged connections are parts of the folding mechanism. The polygonal support structure can thus be folded from the work position into the transport position and vice versa.

It is possible that, in the transport position, at least one polygon corner is accommodated between two polygon edges, forming a concave outer peripheral section. An extremely compact transport position can be achieved in this way.

In one variant, at least one region of the outer skin, which lies on one of the struts, forms a first outer skin longitudinal dimension. The outer skin longitudinal dimension thus substantially corresponds to a longitudinal dimension of that strut on which the region of the outer skin lies. Since the first outer skin longitudinal dimension has the greatest length compared to the remaining outer skin longitudinal dimensions, the first outer skin longitudinal dimension thus corresponds to the length of the longest strut. In the transport position, the container body is folded such that this longest strut defines the overall length of the container body.

The struts can be rigid. They can thus only be moved relative to one another by means of joints. As a result, the container body can be moved in a defined manner, in particular from the transport position to the work position and vice versa.

At least one outer skin section can also be folded into an inside of the container body in the transport position. This ensures that the container body only has a comparatively small volume and comparatively small outer dimensions in the transport position. In other words, the container body is compact in the transport position.

The container body preferably extends along a main flow direction in the work position. The main flow direction runs again from an outer skin surface, which comprises an inlet for the mixture of air and workpiece particles, in the direction of an outer skin surface opposite it. By virtue of such an extension, the mixture of air and workpiece particles flowing into the collecting container can be reliably, in particular continuously or constantly, slowed down with the collecting container. Turbulence and/or back-flow of the mixture of air and workpiece particles is thereby prevented or ruled out. The mixture of air and workpiece particles is thus distributed within the container body with a high degree of uniformity. As a result, comparatively large surface portions of the outer skin can participate in the filtration of the mixture of air and workpiece particles. The aforementioned filtering function can thus be provided with a high degree of reliability.

Advantageously, the container body extends transverse to the main flow direction in the transport position. It is understood that, in the transport position, no mixture of air and workpiece particles flows into the container body and thus, strictly speaking, there is no main flow direction. However, what is meant is that, in the transport position, the container body extends transverse to a direction which runs from an outer skin surface, which comprises an inlet for the mixture of air and workpiece particles, in the direction of an outer skin surface opposite it. The collecting container is thus particularly compact in this direction.

According to one variant, the outer skin has a corrugated or serrated outer skin section at least in the work position. An outer skin surface area can be locally increased via such outer skin sections without influencing the overall dimensions of the container body. In this way, a relatively large outer skin surface can be provided within a comparatively small volume, which, as already explained, acts as a filter. The filter properties of the container body are thus improved by means of the corrugated or serrated outer skin section.

The corrugated or serrate outer skin section can be formed by at least one corrugated or serrated strut. In this way, a corrugated or serrated outer skin section can be easily formed structurally. In this context, the outer skin can be formed by a covering, which is elastic in sections, for example. However, elasticity is not strictly necessary.

In one variant, it can be provided that, in the work position, when viewed along a main flow direction, a perimeter of the container body is either consistent or changes linearly along the main flow direction. Alternatively, in the work position, when viewed transverse to the main flow direction, a perimeter of the container body can either be consistent or change linearly transverse to the main flow direction. The change can be an increase or a decrease. A linear variation is understood to mean that adjacent perimeters, which are, for example, plotted along the main flow direction or transverse to it, are in a linear relationship, i.e., can be mathematically described by a linear function. If the perimeter is consistent, a covering can be used which has a constant perimeter. This is then pulled over the struts of the container body, wherein the serrations or corrugations compensate for each other along the perimeter. A structurally comparatively simple covering can thus be used. Furthermore, the process of mounting the covering is simplified. The same applies if the perimeter increases linearly or decreases linearly. In both cases, the geometry that a corresponding covering must have is developable. This means that a covering mounted on the container body does not need to have any elastic stretching or any non-contacting section of material. In all variants, the container body has a comparatively large outer skin surface, which acts as a filter surface.

According to one embodiment, at least two corrugated or serrated struts run along the main flow direction and each perimeter extends over a corrugated peak or a serrated peak of one of the struts and through a corrugated trough or a serrated trough of the other strut. In this context, a corrugated peak and a serrated peak are understood as that part of the strut that runs above a notional zero line. Accordingly, a corrugated trough and a serrated trough are understood as that part of the strut that runs below a notional zero line. In this way, corrugated or serrated outer skin sections are generated, which can also be referred to as folded outer skin sections. However, a perimeter remains constant along the main flow direction, i.e. corrugated peaks and corrugated troughs as well as serrated peaks and serrated troughs compensate each other on the perimeter. A covering can thus be used which is developable in terms of the perimeter. The covering thus does not need to be elastically deformable, which does not, of course, rule out the use of elastically deformable coverings.

The outer skin preferably has at least one elastically deformable outer skin section. This means that users do not need to manipulate the outer skin when the container body is moved from the transport position to the work position and vice versa. As a result, moving from the transport position to the work position is particularly easy. In addition, an elastic outer skin section can be used to specifically apply a force resulting from elastic deformation to another component of the container body, such as to an element of the support structure. As a result, the container body can be stabilised in a simple and reliable manner.

The collecting container can be moved from the transport position to the work position via an intermediate position and vice versa. The elastically deformable outer skin section is stretched to the maximum in the intermediate position. In other words, the collecting container is bi-stable and assumes a stable state both in the transport position and in the work position. The collecting container is unstable in the intermediate position. This ensures that the collecting container always assumes a defined state. The elastically deformable outer skin section acts as a spring or energy storage element.

In one variant, the outer skin has a light entry section, which is translucent. Furthermore, the outer skin has a viewing window section, which is transparent. At least one point of the light entry section is connected to at least one point of the viewing window section by a straight line-of-sight axis. A user of the collecting container and a hand-held tool coupled thereto can thus detect a current fill level by looking inside the collecting container through the viewing window section. Light can enter the inside of the collecting container through the light entry section. As a result, that region inside the collecting container is illuminated by means of light that enters via the light entry section. A current fill level of the collecting container can thus be detected with a high degree of precision and reliability. At the same time, all remaining sections of the outer skin, i.e. all sections apart from the light entry section and viewing window section, are permeable to air and can perform the desired filtering function for separating workpiece particles above a predetermined particle size and air. Optionally, the light entry section is also permeable to air and acts as a filter. It should be emphasised that the light entry section is a section of the outer skin and thus always comprises outer skin material. In other words, the light entry section is not designed as an opening. The filtering effect is thus only marginally influenced by the viewing window section and, where appropriate, the light entry section.

In one variant, a discharge opening is arranged in the outer skin for removing workpiece particles form the container body and a discharge direction associated with the discharge opening extends from the inside of the container body through the discharge opening. The discharge direction is substantially perpendicular to an opening cross-section of the discharge opening. Furthermore, a closure means is provided, which can be attached to the container body at least in a closed position so that the discharge opening can be selectively closed by means of the closure means. In a position of use of the collecting container, when the closure means is in an open position, the discharge direction has an extension component pointing vertically in the direction of a machining zone. In the closed position of the closure means, the discharge opening is closed by means of the closure means. In the open close, the discharge opening is open. In the open position, the closure means can be connected to the container body or separated from the container body. A position of use of the collecting container corresponds to that position which the collecting container assumes when it is coupled to an associated hand-held tool and the hand-held tool is in a normal position or reference position. A machining zone lies along a vertical direction below the hand-held tool used to perform the machining. The machining zone is thus also vertically beneath the collecting container. Information on the machining zone and position of use refers to this case. It is understood that some hand-held tools which can also be equipped with collecting containers, can also be used for vertical or overhead work. However, such work positions are considered the exception in this case and not used as a reference. In the position of use, a central axis of the connecting piece usually has a horizontal extension component. The horizontal extension component is preferably greater than a vertical extension component of the central axis of the connecting piece. The horizontal extension component of the central axis of the connecting piece is more preferably at least twice as great as the vertical extension component. In the position of use of the collecting container, the discharge direction thus has an extension component that points vertically downwards. Workpiece particles present inside the collecting container can thus leave the inside of the collecting container through the discharge opening by means of gravity. The collecting container can remain coupled to the associated hand-held tool in the process, wherein the hand-held tool can assume the normal position. In other words, the hand-held tool with the coupled collecting container cannot be moved to an ergonomically uncomfortable position. As a result, the collecting container can be emptied in a particularly simple manner. The fact that the discharge direction has an extension component in the vertically downwards direction also means that the workpiece particles can be specifically emptied into a container positioned below the collecting container. Undesired contamination as a result of workpiece particles it thus avoided.

The connecting piece can have a free end, which protrudes from the container body. A connector cover can be provided, which is rotatably mounted on the connecting piece and can selectively close and open the connecting piece at the free end. The connector cover thus closes the connecting piece at the end protruding from the container body. As a consequence, in the closed state of the connector cover, at least those sections of the connecting piece through which a mixture of air and workpiece particles flows when the collecting container is in operation are located on the same side of the connector cover as the container body. In other words, in the closed state of the connector cover, those sections of the connecting piece through which a mixture of air and workpiece particles flows when the collecting container is in operation are separated from the surroundings of the collecting container by means of the connector cover. This means that no workpiece particles can escape from this section of the connecting piece. Undesired contamination can thus be prevented. Thanks to being rotatably mounted on the connecting piece, it remains simple to move the connector cover from an open state to the closed state and vice versa. It is understood that the connector cover being rotatably mounted on the connecting piece only enables rotational movement of the connector cover relative to the connecting piece. All other degrees of freedom of movement are blocked by the mounting. Another advantage of the connector cover of the collecting container according to the invention is that, in an open state, it is located outside the sections of the connecting piece through which a mixture of air and workpiece particles flows during operation of the collecting container. In other words, such flow is not hindered or restricted by the connector cover.

The object is also achieved by an assembly, which comprises a motor-driven hand-held device and a collecting container according to the invention. The collecting container is fluidically coupled to the hand-held tool so that a mixture of air and workpiece particles can be fed from the hand-held tool into the collecting container. The fluidic coupling can, for example, be achieved via a connecting piece which is provided on the collecting container and is fluidically connected to an inside of the container body. By virtue of the fact that the container body has a comparatively large volume in the work position and a comparatively small volume in the transport position, the assembly only has to interrupt its operation comparatively rarely in order to empty the collecting container. At the same time, the assembly is very compact when it is to be transported, i.e. the hand-held tool is not in operation and the collecting container is in the transport position.

A main extension of the container body is oriented transverse to the main flow direction in the transport position. In this context, the main extension of the container body refers to its longest dimension. The result is a compact assembly consisting of a hand-held tool and a collecting container.

In one variant, in the transport position, the container body does not exceed a height of the hand-held tool defined perpendicular to a support plate of the hand-held tool. In this context, a support plate is understood to mean a plate-shaped component of the hand-held tool, which is provided to be placed against a workpiece to be machined or to slide along a workpiece to be machined. The container body is thus at the same height or lower than the hand-held tool in the transport position. This results in a compact design and good transportability of the assembly.

Alternatively or in addition, a length of the container body along a longitudinal direction of the hand-held tool in the transport position is no more than 50% of a length of the support plate. In this context, a longitudinal direction of the tool corresponds to a main work direction of the hand-held tool. In more preferred variants, a length of the container body along the longitudinal direction of the hand-held tool in the transport position is no more than 20%, no more than 30% or no more than 40% of the length of the support plate.

In the event that the hand-held tool is a saw with a circular disc-shaped saw blade, e.g. a circular saw, a length of the container body along a longitudinal direction of the hand-held tool in the transport direction is no more than 50% of a saw blade diameter. 50% of the saw blade diameter corresponds to the saw blade radius.

In one alternative, a width protrusion of the container body beyond a width of the support plate of the hand-held tool in the transport position is no more than 40% of the width of the support plate. More preferably, the width protrusion is no more than 15%, no more than 20%, no more than 25%, no more than 30% or no more than 35% of the width of the support plate. Such a configuration also results in a compact assembly.

In the event that the hand-held tool is a saw with a circular disc-shaped saw blade, e.g. a circular saw, a width protrusion can be no more than 50% of a saw blade radius.

The object is also achieved by a hand-held tool system, which comprises an assembly according to the invention and a storage container. The assembly is arranged inside the storage container. In this context, the collecting container is coupled to the hand-held tool. It therefore does not have to be decoupled before the hand-held tool and collecting container are positioned inside the storage container. This simplifies handling of the assembly made up of the hand-held tool and collecting container. In the event that the storage container is used for transport, the storage container can also be referred to as a transport container. Such storage containers are sometimes also referred to as “systainers”.

The container body preferably assumes the transport position here. The assembly made up of the hand-held tool and collecting container is thus compact. A comparatively small storage container is thus sufficient to accommodate the assembly made up of the hand-held tool and collecting container. The storage container is thus also compact.

Moreover, the effects and advantages already set out in connection with the collecting container according to the invention and the assembly according to the invention also apply to the hand-held tool system and vice versa.

The invention is explained below based on various exemplary embodiments, which are shown in the appended drawings. In the drawings:

FIG. 1 shows a hand-held tool system with a storage container, in which an assembly, which comprises a motor-driven hand-held tool and a collecting container according to a first embodiment, is positioned, wherein a covering of the collecting container is omitted,

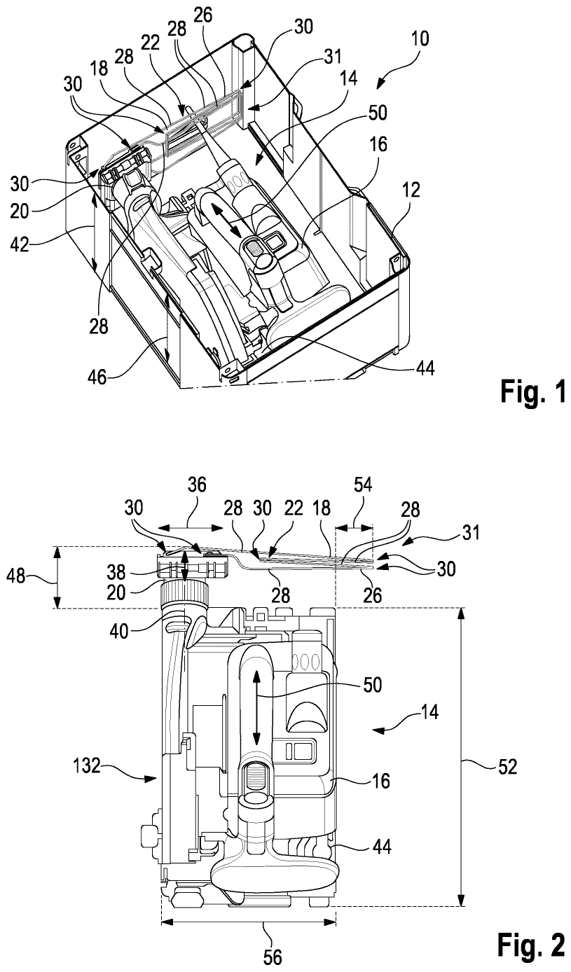

FIG. 2 shows the assembly shown in FIG. 1 in an isolated plan view,

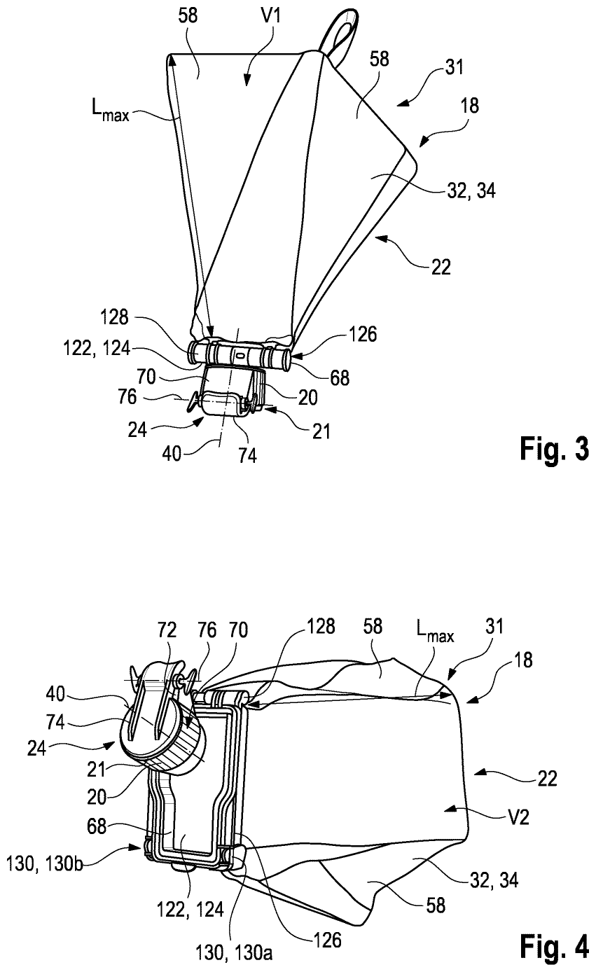

FIG. 3 shows the collecting container shown in FIGS. 1 and 2 in an isolated view, wherein the collecting container assumes a work position,

FIG. 4 shows the collecting container shown in FIGS. 1 to 3, wherein the collecting container assumes a transport position,

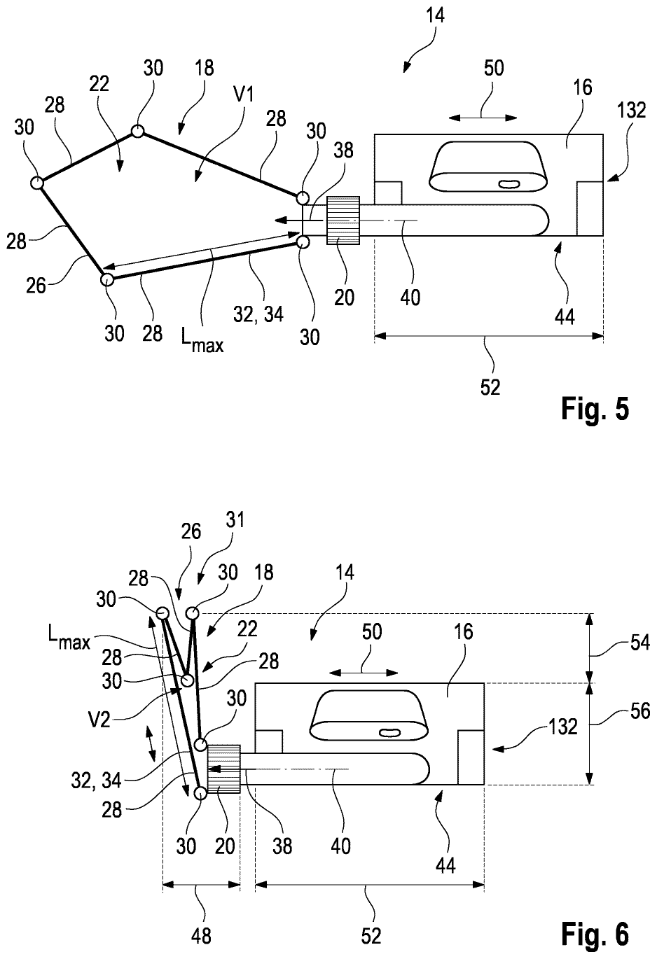

FIG. 5 shows the assembly shown in FIGS. 1 and 2 in a schematic plan view, wherein the collecting container assumes the work position,

FIG. 6 shows the assembly shown in FIGS. 1 and 2 in a schematic plan view corresponding to the view in FIG. 5, wherein the collecting container assumes the transport position,

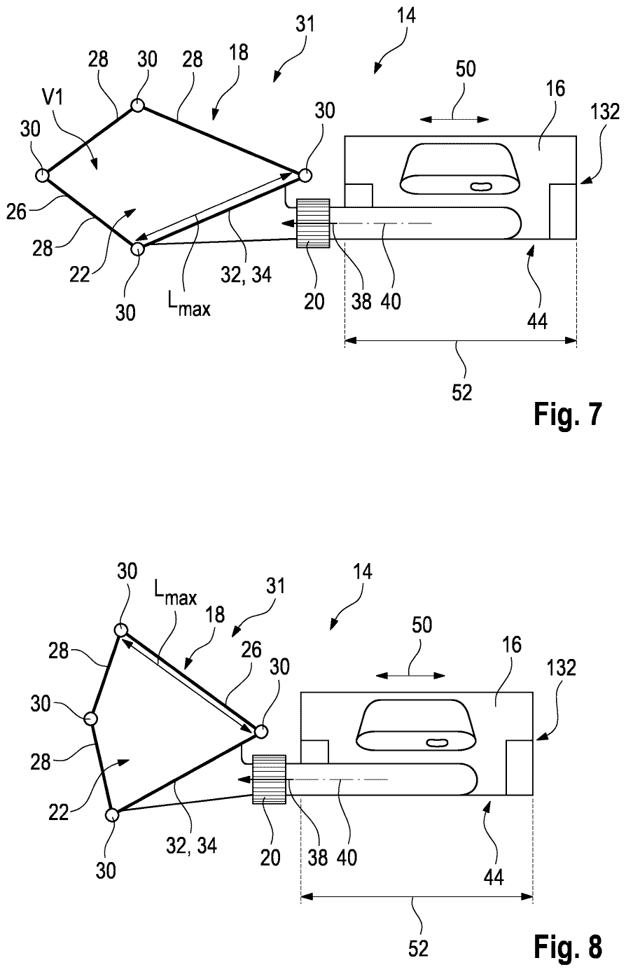

FIG. 7 shows in a plan view corresponding to FIGS. 5 and 6 an assembly with a collecting container according to a second embodiment, wherein the collecting container assumes the work position,

FIG. 8 shows the assembly shown in FIG. 7, wherein the collecting container assumes an intermediate position,

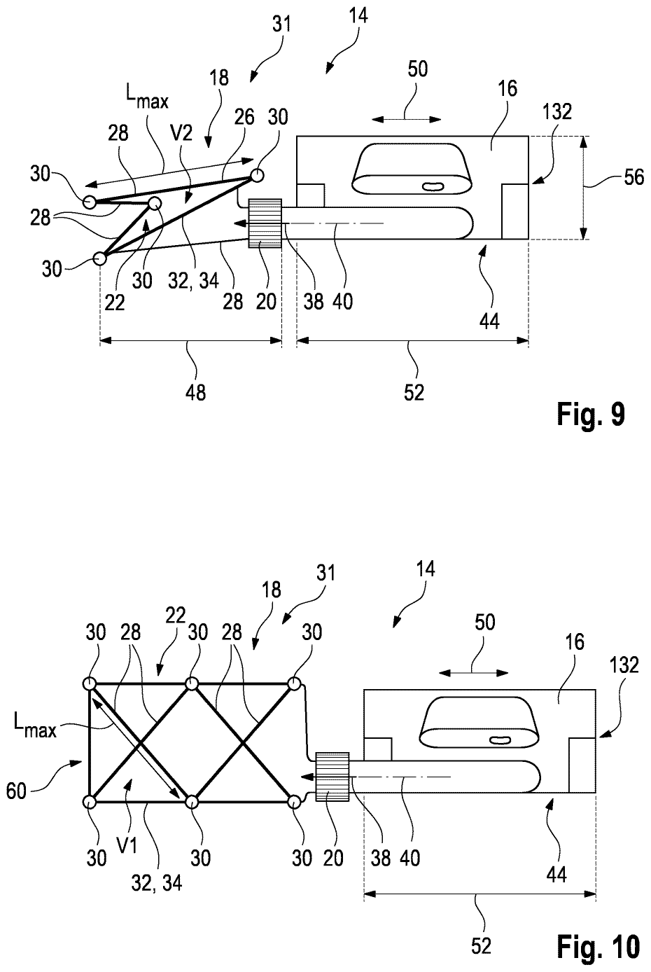

FIG. 9 shows the assembly shown in FIGS. 7 and 8, wherein the collecting container assumes the transport position,

FIG. 10 shows in a plan view corresponding to FIGS. 5 to 9 an assembly with a collecting container according to a third embodiment, wherein the collecting container assumes the work position,

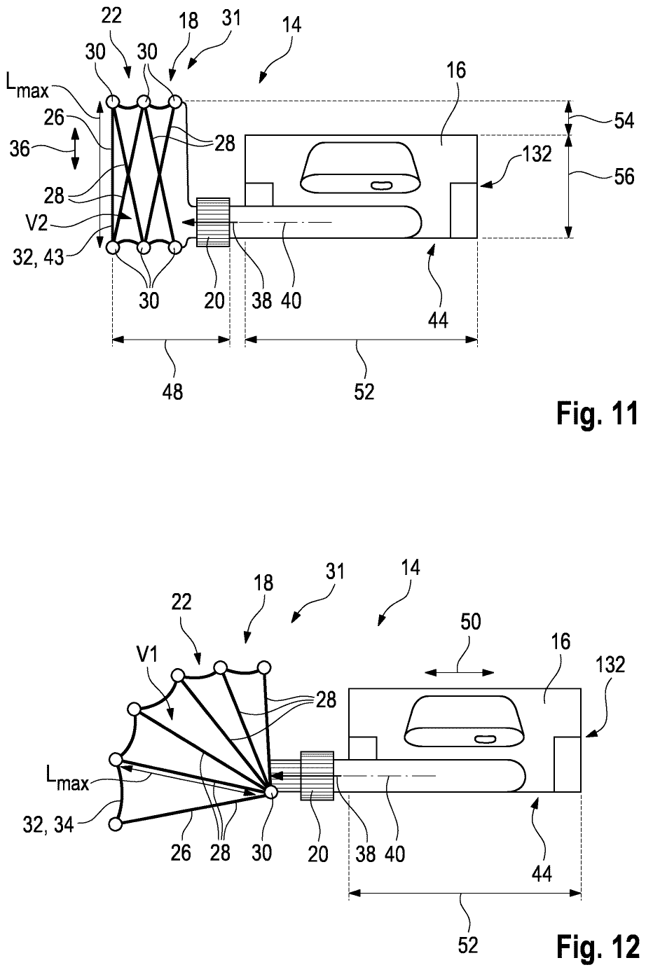

FIG. 11 shows the assembly shown in FIG. 10, wherein the collecting container assumes the transport position,

FIG. 12 shows in a plan view corresponding to FIGS. 5 to 11 an assembly with a collecting container according to a fourth embodiment, wherein the collecting container assumes the work position,

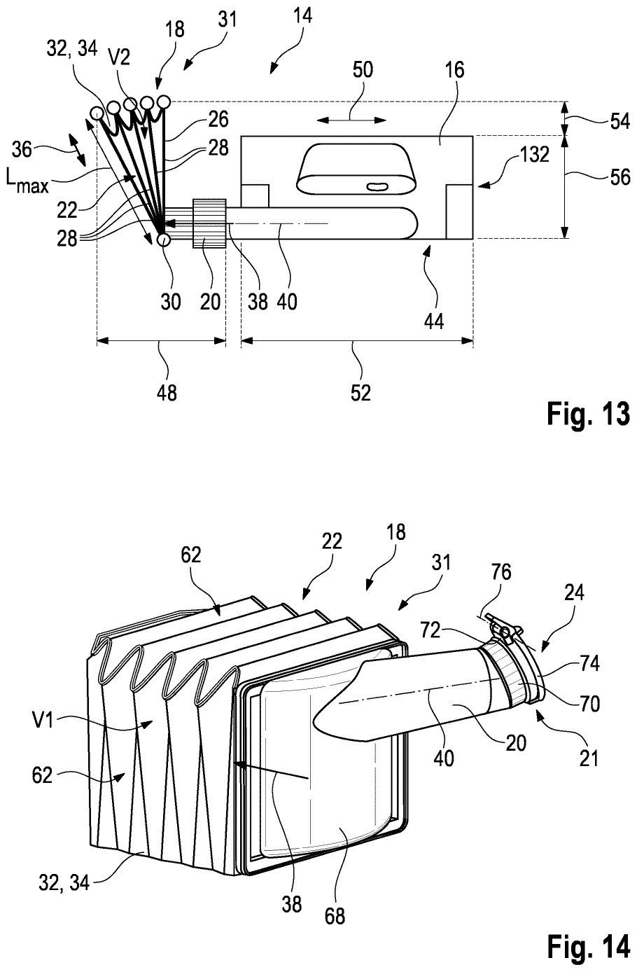

FIG. 13 shows the assembly shown in FIG. 12, wherein the collecting container assumes the transport position,

FIG. 14 shows a collecting container according to a fifth embodiment in a perspective view,

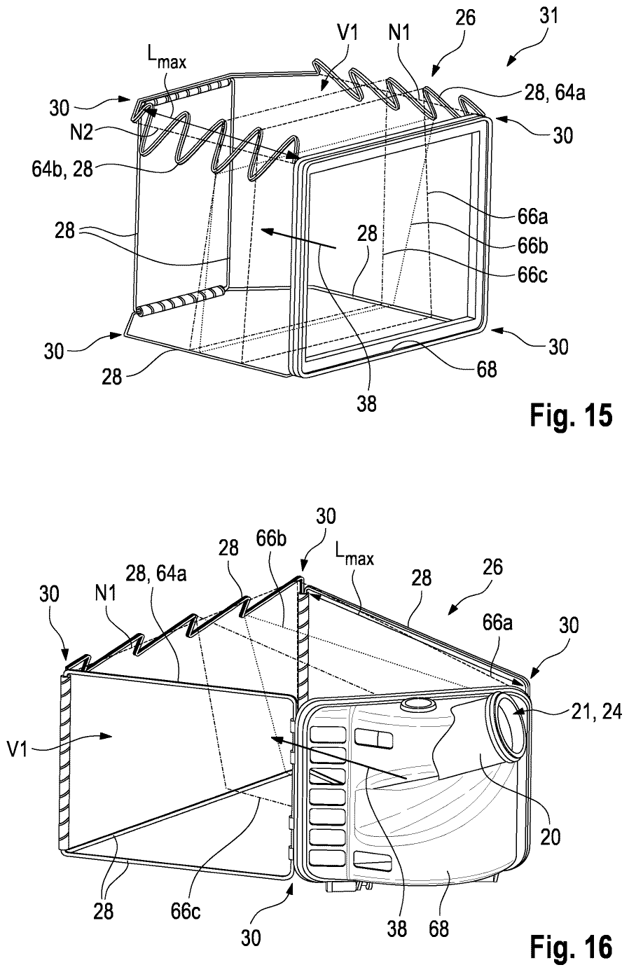

FIG. 15 shows a view of the collecting container shown in FIG. 14, wherein a covering of the collecting container is omitted,

FIG. 16 shows a collecting container according to a sixth embodiment in a perspective view, wherein a covering of the collecting container is omitted,

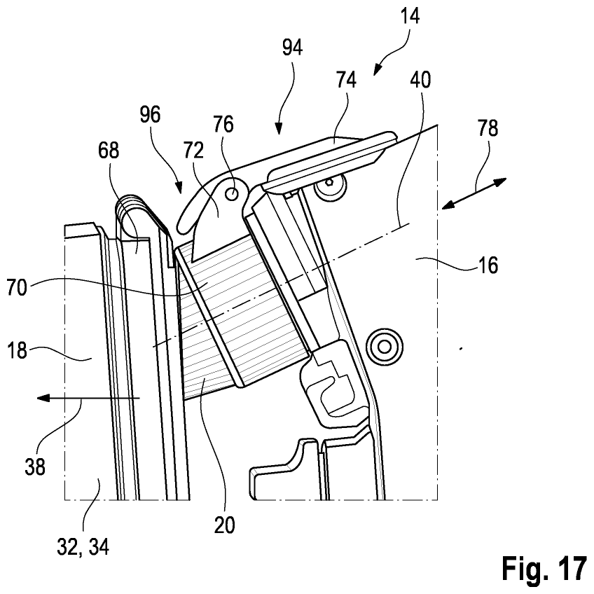

FIG. 17 shows in a detail view a region of the assembly shown in FIGS. 1 to 6, in which the collecting container according to the first embodiment is coupled to the motor-driven hand-held tool,

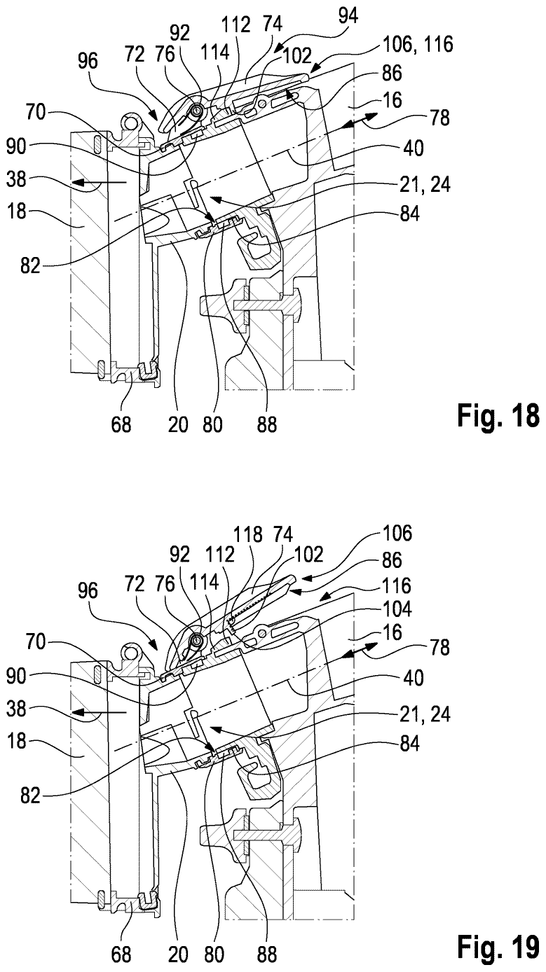

FIG. 18 shows a longitudinal section through the region shown in FIG. 17,

FIG. 19 shows a longitudinal section corresponding to FIG. 18, wherein the collecting container is unlocked from the motor-driven hand-held tool,

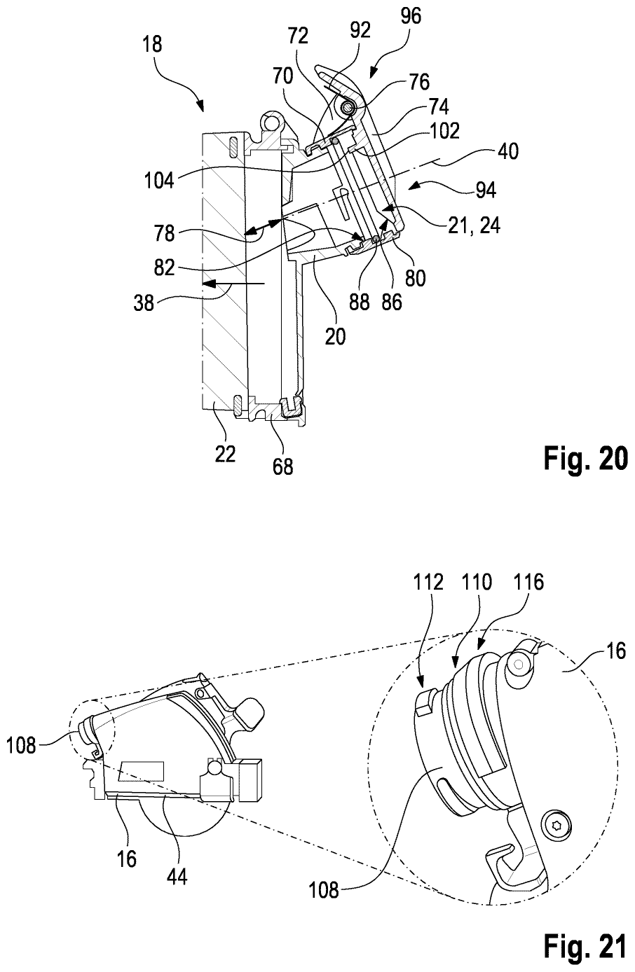

FIG. 20 shows a longitudinal section corresponding to FIGS. 18 and 19, wherein the collecting container is decoupled from the motor-driven hand-held tool,

FIG. 21 shows a detail view of the motor-driven hand-held tool shown in FIGS. 17 to 19, wherein the collecting container is decoupled from the motor-driven hand-held tool,

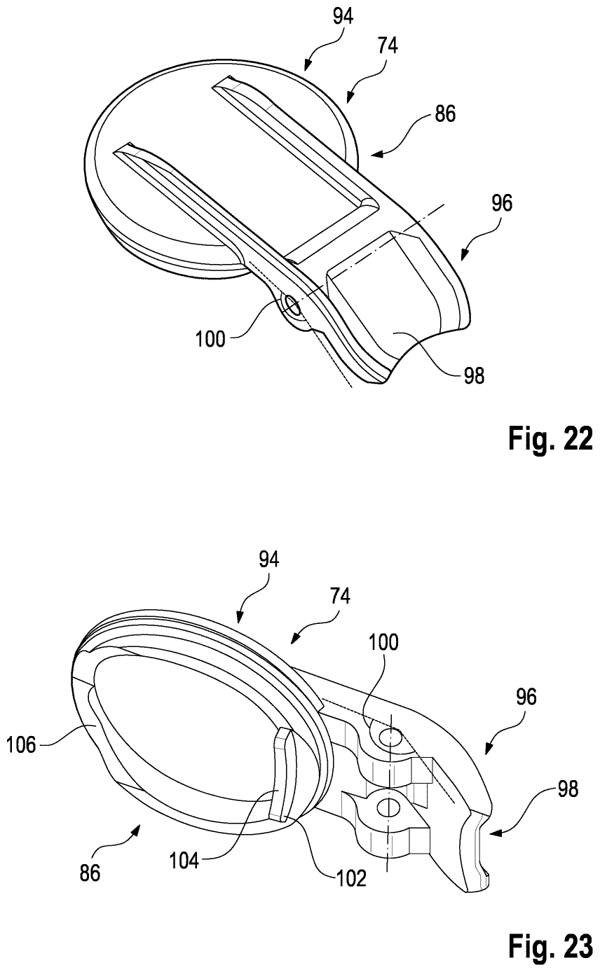

FIG. 22 shows a connector cover of the collecting container shown in FIGS. 17 to 20 in a perspective, isolated view,

FIG. 23 shows the connector cover shown in FIG. 22 in another perspective, isolated view,

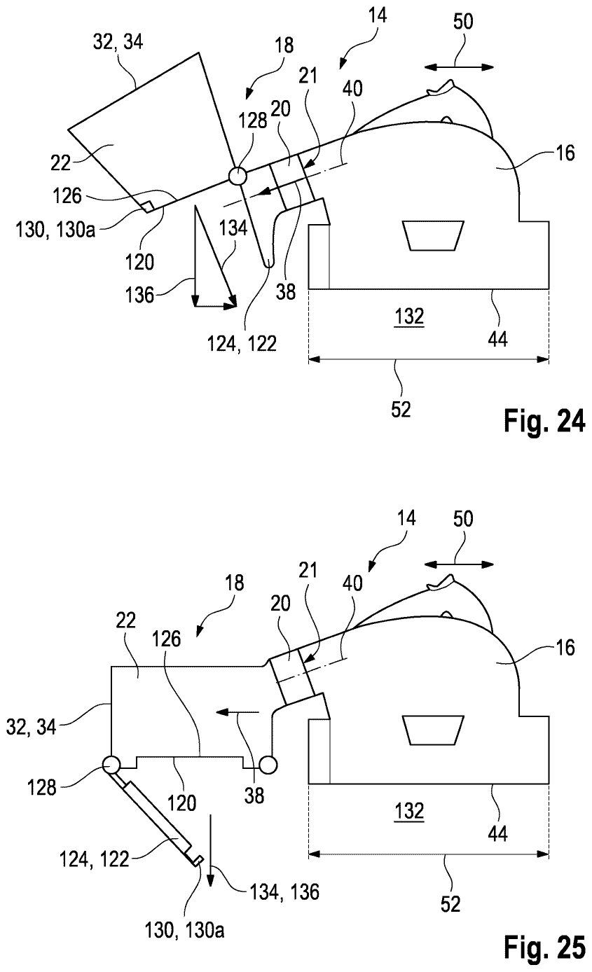

FIG. 24 shows the assembly shown in FIGS. 1 and 2 in a schematic view, wherein the collecting container is emptied,

FIG. 25 shows a variant of the assembly shown in FIG. 24 in a schematic view, wherein the collecting container is emptied,

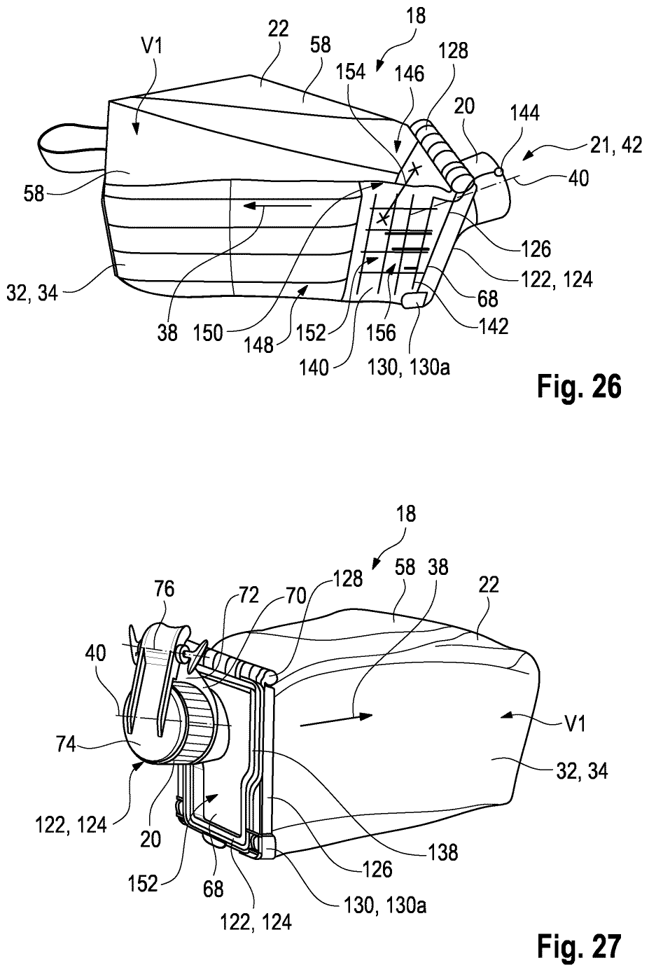

FIG. 26 shows the collecting container according to the first embodiment shown in FIGS. 3 and 4 in another perspective view, and

FIG. 27 shows a variant of the collecting container shown in FIG. 26.

FIG. 1 shows a hand-held tool system 10.

The hand-held tool system 10 comprises a storage container 12 and an assembly 14, which has a motor-driven hand-held tool 16 and a collecting container 18 for workpiece particles.

In the present example, the motor-driven hand-held tool 16 is a hand-held circular saw. However, this should only be understood as an example.

The collecting container 18 is fluidically coupled to the hand-held tool 16 so that, when working with the hand-held tool 16, a mixture of air and workpiece particles can be fed from the hand-held tool 16 into the collecting container 18.

For this, the collecting container 18 has a connecting piece 20, which forms an inlet opening 21, and a container body 22 with a flexible shape, in which a certain quantity of workpiece particles can be accommodated.

The connecting piece 20 is designed to be coupled to the hand-held tool 16 at its free end 24. At its opposite end, the connecting piece 20 opens into the container body 22.

The container body 22 comprises a support structure 26, which is composed of a plurality of rigid struts 28, which are connected to one another via joints 30. The struts 28 and joints 30 form a folding mechanism 31, which will be explained below.

Furthermore, the container body 22 comprises an outer skin 32, which is formed as a covering 34 surrounding the support structure 26. It should be noted that in order to improve visibility of the support structure 26, the outer skin 32 is not shown in the illustrations in FIGS. 1, 2, 5 and 6.

The container body 22 assumes a transport position in FIGS. 1 and 2.

Furthermore, the assembly 14 is arranged inside the storage container 12 in the illustration according to FIG. 1. A cover of the storage container 12 is not shown here. It should be noted that in particular in the illustration according to FIG. 1, i.e. in a situation where the assembly is arranged inside the storage container 12, the collecting container 18 is fluidically coupled to the hand-held tool 16. This is made possible by the compact nature of the transport position.

A main extension 36 of the container body 22, i.e. the direction of the comparatively largest longitudinal dimension of the container body 22, runs transverse to a main flow direction 38. In this context, the main flow direction 38 runs from an outer skin surface supporting the connecting piece 20 in the direction of an outer skin surface opposite it. It is understood that the main flow direction 38 is defined independently of whether a mixture of air and workpiece particles actually flows from the hand-held tool 16 into the collecting container 18 or not.

Moreover, in the transport position, a height 42 of the container body 22 is no greater than a height 46 of the hand-held tool 16 defined perpendicular to a support plate 44 of the hand-held tool 16. In other words, in the transport position, a height 42 of the container body 22 does not exceed the height 46 of the hand-held tool 16.

In addition, a length 48 of the container body 22 along a longitudinal direction 50 of the hand-held tool 16 is no more than 50% of a length 52 of the support plate 44 when the container body 22 is in the transport position. In the example shown, the length 48 of the container body 22 is approximately 20% of the length 52 of the support plate 44.

Furthermore, a width protrusion 54 of the container body 22 beyond a width 56 of the support plate 44 in the transport position is approximately 40% of the width 56 of the support plate 44.

The collecting container 18 according to the first embodiment is shown in more detail in FIGS. 3 to 6. FIGS. 4 and 6 respectively show the transport position of the container body 22. FIGS. 3 and 5 show a work position of the container body 22, which will be explained below.

In the embodiment shown, the support structure 26 is polygonal in a lateral view in relation to the main flow direction 34. In this context, the joints 30 form the polygon corners of the poly gonal shape and the struts 28 form the polygon edges.

The polygon has five polygon corners in this case.

In the transport position, a polygon corner, i.e. a joint 30, is accommodated between two polygon edges, i.e. between two struts 28, forming a concave outer peripheral section.

As a result, an outer skin section, i.e. a section of the outer skin 32, is folded into an inside of the container body 22 in the transport position.

The container body 22 can be moved to the work position, which is shown in FIGS. 3 and 5, by means of the folding mechanism 31. The container body 22 extends along the main flow direction 38 in the work position. This means that a largest outer dimension of the container body 22 is oriented in the same direction as the main flow direction 38.

In the work position, the outer skin 32 encloses a first volume V1, which is much larger than a second volume V2, which the outer skin 32 encloses in the transport position. A comparatively large quantity of workpiece particles can thus be accommodated inside the container body 22 in the work position.

In the work position, the collecting container 18 has at least one first outer skin longitudinal dimension Lmax, which has a greatest length in comparison to the remaining outer skin longitudinal dimensions of the collecting container 18.

In the embodiment shown, the first outer skin longitudinal dimension Lmax is formed by a region of the outer skin 32, which lies on one of the struts 28.

The first outer skin longitudinal dimension Lmax thus corresponds to the length of the longest strut 28 of the collecting container 18.

The fact that the first volume V1 enclosed by the outer skin 32 in the work position is much larger than the second volume V2 enclosed in the transport position, wherein at the same time the container body 22 is extremely compact in the transport position, is due to the fact that the first outer skin longitudinal dimension Lmax defines a greatest length of the container body in the transport position. In other words, the first outer skin longitudinal dimension Lmax determines the greatest outer dimension of the container body 22 in the transport position.

It is understood that the container body 22 can also be moved from the work position back to the transport position by means of the folding mechanism 31. In other words, the container body 22 can selectively assume the transport position or work position by using the folding mechanism 31.

In addition, the outer skin 32 comprises at least one elastically deformable outer skin section 58.

The folding mechanism 31 is configured such that the elastically deformable outer skin section 58 is elastically stretched to the maximum in an intermediate position which the container body 22 assumes when it is moved from the transport position to the work position and vice versa.

This means that the container body 22 can be held mechanically stable in the work position and the transport position by means of the elastically deformable outer skin section 58. The intermediate position is mechanically unstable.

FIGS. 7, 8 and 9 show the assembly 14, wherein the collecting container 18 according to a second embodiment is formed. Only the differences to the first embodiment will be explained below. Similar or corresponding components bear the same reference numerals.

As above, the support structure 26 is polygonal in a lateral view in relation to the main flow direction 34, wherein the joints 30 again form the polygon corners of the polygonal shape and the struts 28 again form the polygon edges.

However, the polygon only has four polygon corners in this case.

Another difference is that the main extension 36 of the container body 22 in the transport position (see FIG. 9) no longer runs transverse, but rather at an angle of approx. 30 degrees to the main flow direction 38.

This results in a situation where the container body 22 has no width protrusion over the width 56 of the support plate 44 in the transport position.

The length 48 of the container body 22 along the longitudinal direction 50 of the hand-held tool 16 is now approx. 70% of a length 52 of the support plate 44 when the container body 22 is in the transport position.

Otherwise, reference can be made to the explanations regarding the collecting container 18 according to the first embodiment.

FIGS. 10 and 11 show the assembly 14, wherein the collecting container 18 according to a third embodiment is formed. Only the differences to the aforementioned embodiments will be explained below. Similar or corresponding components bear the same reference numerals.

In this embodiment, the struts 28 and joints 30 form a cross frame 60. In the work position (see FIG. 10), central regions of pairs of struts assigned to each other thus intersect in a cross-like manner.

In the transport position (see FIG. 11), the pairs of struts assigned to each other are substantially placed on top of one other.

In this context, the first outer skin longitudinal dimension Lmax is formed by a region of the outer skin 32, which lies on one of the struts 28 arranged in a cross-like manner.

In other words, the first outer skin longitudinal dimension Lmax again corresponds to the length of the longest strut 28.

Unlike the aforementioned embodiments, the outer skin is further elastically deformable overall in the third embodiment.

The width protrusion in the transport position of the container body is now approximately 15%. The length 48 of the container body 22 along the longitudinal direction 50 of the hand-held tool 16 is now approx. 40% of a length 52 of the support plate 44 when the container body 22 is in the transport position.

FIGS. 12 and 13 show the assembly 14, wherein the collecting container 18 according to a fourth embodiment is formed. Only the differences to the aforementioned embodiments will be explained below. Similar or corresponding components bear the same reference numerals.

In this embodiment, the struts 28 are respectively C-shaped.

They respectively have a joint 30 at the ends of the C-shape, via which the struts 28 are hingedly connected to one another.

In the embodiment shown, all joints 30 has the same joint axis. The struts 28 can thus be rotated relative to one another in a fan-like manner and can in this way be moved between the work position, in which the struts 28 are fanned out (see FIG. 12), and the transport position, in which the struts 28 are positioned on top of one another (FIG. 13).

In this context, the first outer skin longitudinal dimension Lmax is formed by an arc height of the C-shaped struts 28.

Unlike the aforementioned embodiments, the outer skin 32 can be designed overall without an elastic section in the fourth embodiment. The outer skin is thus overall not elastically deformable.

The width protrusion in the transport position of the container body is now approximately 15%. The length 48 of the container body 22 along the longitudinal direction 50 of the hand-held tool 16 is now approx. 40% of a length 52 of the support plate 44 when the container body 22 is in the transport position.

FIGS. 14 and 15 show a fifth embodiment of the collecting container 18. The collecting container 18 according to the fifth embodiment is a variant of the collecting container 18 according to the second embodiment (see FIGS. 7 to 9). Only the differences to the second embodiment will therefore be explained below. Similar or corresponding components bear the same reference numerals.

In the collecting container 18 according to the fifth embodiment, the outer skin 32 has a serrated section 62 in the work position. This serves to increase a surface area of the outer skin 32, wherein at the same time the outer dimensions of the container body 22 can be kept the same compared to a collecting container 18 with an outer skin 32 without a serrated section. The filtering function of the outer skin 32 can be improved as a result.

The serrated section 62 is formed by two of the struts 28 of the support structure 26 being serrated (see FIG. 15). The serrated struts 28 are additionally given reference numeral 64a and reference numeral 64b.

The serrations of the serrated struts 64a, 64b are arranged such that, when viewed along the main flow direction 38, a perimeter of the container body 22 is consistent along the main flow direction 38.

This is achieved by the arrangement of the serrations of the serrated struts 64a, 64b. A notional zero line N1 of the serrations is included in FIG. 15 for the serrated strut 64a for better understanding. A notional zero line N2 is included for the serrated strut 64b.

The zero lines N1, N2 correspond to the course of a straight, i.e. not serrated strut, which could be used instead of the serrated struts 64a, 64b.

Moreover, a plurality of exemplary perimeters 66a, 66b, 66c are shown in FIG. 15.

The serrations of the struts 64a, 64b, i.e. the associated serrated peaks and serrated troughs extend uniformly on both sides of the respective zero line N1, N2. Furthermore, the serrations of the struts 64a, 64b extend respectively in one plane.

However, this plane is inclined relative to the side surfaces of the collecting container 18 delimited by the respective strut 64a, 64b. More precisely, the planes in which the serrations of the struts 64a, 64b run are inclined relative to the side surfaces of the collecting container 18 delimited by the respective strut 64a, 64b such that the plane in which the serrations extend forms the same angle with each of these planes.

The serrated section 62 thus extends over the side surface shown at the front in FIGS. 14 and 15, the side surface shown at the rear in FIGS. 14 and 15 and the side surface shown at the top in FIGS. 14 and 15.

Due to the inclination of the planes in which the serrations of the struts 64a, 64b run, the associated serrated peaks and serrated troughs compensate each other in such a way that the perimeter of the container body 22 is constant along the main flow direction 38. The exemplary perimeters 66a, 66b, 66c in FIG. 15 are thus the same size.

As a result, the outer skin 32 can be designed without an elastic section. In addition, the outer skin 32 has a comparatively simple geometry, in particular if it is developed.

In the embodiment according to FIGS. 14 and 15, the outer skin 32 is made from a single, continuous piece of material, i.e. is not composed of a plurality of parts.

FIG. 16 shows a sixth embodiment of the collecting container 18. The collecting container 18 according to the sixth embodiment is a variant of the collecting container 18 according to the fifth embodiment (see FIGS. 14 to 15). Only the differences to the fifth embodiment will therefore be explained below. Similar or corresponding components bear the same reference numerals.

Once again, a notional zero line N1 of the serrations is included for the serrated strut 64a for better understanding.

Moreover, a plurality of exemplary perimeters 66a, 66b, 66c are also shown in FIG. 16.

In the sixth embodiment, the support structure 26 only comprises a single serrated strut 64a.

As usual, the serrations of the strut 64a, i.e. the associated serrated peaks and serrated troughs, extend uniformly on both sides of the zero line N1. Furthermore, the serrations of the strut 64a extend in one plane.

As already mentioned in connection with FIGS. 14 and 15, the plane in which the serrations extend is inclined relative to the side surfaces of the collecting container 18 delimited by the strut 64a, wherein the plane in which the serrations extend forms the same angle with each of these side surfaces.

The has the effect of increasing the surface area whilst keeping the perimeter of the outer skin 32 consistent.

However, it is understood that in the example in FIG. 16, the perimeter in general and in particular the exemplary perimeters 66a, 66b, 66c are consistent when viewed transverse to the main flow direction 38.

In the fifth and sixth embodiment (see FIGS. 14 to 16), corrugated struts can also be used instead of serrated struts 64a, 64b. This ensures that the outer skin 32 of the collecting container 18 has a corrugated section. Corrugated struts differ from serrated struts in that they have no straight sections at least in the region of the corrugation. The aforementioned statements are applicable in a similar manner to collecting containers 18, whose outer skin 32 has a corrugated section.

FIG. 17 to 19 show a region of the assembly 14 shown in FIGS. 1 to 6 in detail, in which the collecting container 18 according to the first embodiment is coupled to the motor-driven hand-held tool 16. This means that the collecting container 18 is fluidically coupled to the hand-held tool 16 via the connecting piece 20 so that a mixture of air and workpiece particles can be fed from the hand-held tool 16 into the collecting container 18.

In the embodiment shown, the connecting piece 20 is provided at a dimensionally stable section 68 of the outer skin 32. Due to this, the collecting container 18, more specifically the container body 22, has a comparatively high dimensional stability in the region of the connecting piece 20 such that the collecting container 18 is easy to handle for coupling to the hand-held tool 16 and for decoupling from the hand-held tool 16.

The connecting piece 20 is also dimensionally stable.

Furthermore, the dimensionally stable section 68 and the connecting piece 20 are produced in one piece.

The free end 24 of the connecting piece 20 protrudes from the container body 22. Furthermore, a bearing block 72 is positioned on the outer perimeter 70 of the connecting piece 20, via which a connector cover 74 is rotatably mounted on the connecting piece 20.

An associated axis of rotation 76, about which the connector cover 74 can be rotated, runs transverse to a longitudinal extension direction 78 of the connecting piece 20.

The axis of rotation 76 is spaced apart from the outer perimeter 70 of the connecting piece 20. A distance between the axis of rotation 76 and the outer perimeter 70 is therefore greater than zero.

By correspondingly rotating about the axis of rotation 76, the connector cover 74 can thus selectively close (see FIG. 20) and open (see FIGS. 17 to 19) the connecting piece 20 at the free end.

The collecting container 18 can only be coupled to the hand-held tool 16 if the connector cover 74 opens the connecting piece 20.

The coupled state is characterised in that a sealing section 80 on the connecting piece side, which is positioned on an inner perimeter 82 of the connecting piece 20 adjacent to the free end 24, is in contact with a sealing section 84 on the hand-held tool side (see FIGS. 18 and 19).

If the connector cover 74 closes the connecting piece 20, i.e. if the connector cover 74 is in the closed position, a sealing section 86 on the cover side is at least in sections opposite the sealing section 80 on the connecting piece side or rests against the sealing section 80 on the connecting piece side (see FIG. 20).

A sealing element 88 in the form of a sealing lip is arranged on the sealing section 80 on the connecting piece side in this case.

A sealing element 90 in the form of a sealing lip is also provided on the sealing section 84 on the hand-held tool side.

The connector cover is pre-loaded into the closed position by means of a spring device 92.

The connector cover 74 is shown in isolation in FIGS. 22 and 23.

The connector cover 74 has a closure section 94, which is designed to selectively close the free end 24 of the connecting piece 20.

Furthermore, the connector cover 74 has an actuation section 96, which comprises an actuation surface 98, which is designed to be pressed by a human finger in order to move the connector cover 74 from the closed position to the open position against the force exerted by the spring device 92. The actuation section 96 is thus designed to manually release the free end 24 of the connecting piece 20.

The connector cover 74 is designed as a single, continuous part. Accordingly, the closure section 94 and the actuation section 96 are also integral but separate from one another.

The closure section 94 and the actuation section 96 form an obtuse angle 100 in a plane of rotation, i.e. along the axis of rotation 76.

In addition, the closure section 94 and actuation section 96 are positioned on opposite sides of the axis of rotation 76.

In other words, the closure section 94 and actuation section 94 are separated from one another.

Furthermore, a retaining rib 102 with a mounting slope 104 is formed on the closure section 94.

The retaining rib 102 is used to lock the collecting container 18 in a position coupled to the motor-driven hand-held tool 16 (see FIGS. 18 and 19).

The retaining rib 102 is positioned on a side of the closure section 94 facing the connecting piece 20. Accordingly, in the closed position, the retaining rib 102 protrudes inside the connecting piece 20.

A recess 106 is also provided on the closure section 94.

The recess 106 serves to receive a section of the hand-held tool 16 in a position of the collecting container 18 coupled to the motor-driven hand-held tool 16 (see FIG. 18).

The recess 106 is also positioned on a side of the closure section 84 facing the connecting piece 20.

The retaining rib 102 is closer to the axis of rotation 76 than the recess 106.

An outlet 108 of the motor-driven hand-held tool 16, which is part of the assembly 14, is shown in detail in FIG. 21.

The outlet 108 is used to remove the mixture of air and workpiece particles from the hand-held tool 16. A retaining bead 112 for coupling the collecting container 18 for workpiece particles is arranged on an outer perimeter 110 of the outlet 108.

The retaining bead 112 is also provided with a mounting slope 114.

Furthermore, the hand-held tool 16 has a contact area 116. It is designed to be in contact with the connector cover when the collecting container 18 is coupled to the hand-held tool 16.

In a situation where the collecting container 18 is coupled to the hand-held tool 16, the connector cover 74 can thus lock the collecting container 18 to the hand-held tool 16. For this purpose, the retaining rib 102 of the connector cover 74 engages behind the retaining bead 112 of the hand-held tool 16. Furthermore, the connector cover 74 is in contact with the contact area 116 of the hand-held tool 16 in the region of the recess 106 at least in sections (see FIGS. 17 and 18).

Due to the fact that the connector cover 74 is pre-loaded into its closed position by means of the spring device 92, the state in which the collecting container 18 is locked to the hand-held tool 16 can only be released by the application of force.

This can occur by applying an actuation pressing force to the actuation section 96.

By means of such actuation, the actuation section 96 can be moved closer to the outer perimeter 70 of the connecting piece in a view along the axis of rotation 76 such that the closure section is lifted off the hand-held tool 16.

In this way, the connector cover 74 can be moved into a release position in which it releases the connecting piece 20 at the free end and forms an angle 118 of more than 90° with a connection cross-section of the connecting piece 20 (see FIG. 19).

In such a position of the connector cover 74, the connecting piece 20 can be removed from the outlet 108 or slid onto the outlet 108 with little resistance. In other words, in such a position of the connector cover 74, the collecting container 18 can be easily coupled to the hand-held tool 16 and just as easily decoupled therefrom.

If the connector cover 74 is not actuated in a state where the collecting container 18 is not coupled to the hand-held tool, it closes the connecting piece 20 (see FIG. 20). In this position, the actuation section 96 is located on a side of the axis of rotation 76 facing away from the connecting piece 20.

In order to release the free end 24 of the connecting piece 20, the connector cover 74 now has to be actuated such that the actuation section 96 is moved to a side of the axis of rotation 76 facing the connecting piece 20 (see FIG. 19).

The connector cover 74 and the associated devices of the collecting container 18 and motor-driven hand-held tool 16 have been explained above based on the collecting container 18 according to the first embodiment (see FIGS. 1 to 6). However, it should be understood that the statements regarding the connector cover 74 and the associated devices of the collecting container 18 and motor-driven hand-held tool 16 apply in a similar manner to the remaining embodiments of the collecting container 18.

As shown in FIG. 24, the dimensionally stable section 68 of the outer skin 32 further comprises a discharge opening 120.

The discharge opening 120 serves to remove workpiece particles from the container body 22, for example when machining of a workpiece has finished and the container body 22 is to be moved into the transport position again, or if a limit fill level of the container body 22 with workpiece particles has been reached during machining of the workpiece.

The collecting container 18 further comprises a closure means 122, which can be attached to the container body 22 at least in a closed position so that the discharge opening 120 can be selectively closed by means of the closure means 122.

In the embodiment shown, the closure means 122 is designed as a dimensionally stable cover 124.

The sections of the dimensionally stable section 68 of the outer skin 32 surrounding the discharge opening 120 further form a dimensionally stable frame 126, which delimits the discharge opening 120.

The closure means 122, more specifically the cover 124, is pivotably attached to the container body 22, more specifically to the dimensionally stable frame 126, via a hinge 128.

In this case, the connecting piece 20 is also arranged on the closure means 122, i.e. on the cover 124. The connecting piece 20 and cover 124 are integrally formed.

The inlet opening 21 and discharge opening 120 are thus positioned on the same outer skin surface of the outer skin 32.

The collecting container 18 further has a locking unit 130 shown merely schematically in FIG. 24, by means of which the closure means 122 can be locked in a closed position to the frame 126.

The locking unit 130 comprises a first actuation surface 130a and a second actuation surface 130b, via which the locking unit 130 can be actuated.

The first actuation surface 130a and second actuation surface 130b are spaced apart by no more than 15 cm from one another. The first actuation surface 130a and second actuation surface 130b can thus be touched at the same time by different fingers on a single human hand. In other words, the locking unit 130 can be actuated with a single human hand.

In FIG. 24, the hand-held tool 16 is shown in a machining position. A machining zone 132 is located beneath the hand-held tool 16 in FIG. 24.

The collecting container 18 is coupled to the hand-held tool 16. As a result, the hinge 128 is positioned on a side of the connecting piece 20 facing away from the machining zone 132 in a position of use of the collecting container 18.

This firstly has the effect that, in the position of use of the collecting container 18, i.e. in the position shown in FIG. 24, gravity acts in the closing direction on the closure means 122 and container body 22.

Furthermore, in a position of use of the collecting container 18, i.e. in the position shown in FIG. 24, a discharge direction 134, which is perpendicular to an opening cross-section of the discharge opening 120 and extends from an inside of the container body 22 through the discharge opening 120, is directed towards the machining zone 132.

More specifically, the discharge direction 134 has an extension component 136 pointing vertically in the direction of the machining zone 132 in a situation where the closure means 122 is in an open position.

It should be emphasised that the collecting container 18 is coupled to the hand-held tool 16 both in an open position of the closure means 122 and in a closed position of the closure means 122.

FIG. 25 shows a variant of the embodiment shown in FIG. 24. The discharge opening 120 is arranged on an outer skin surface of the outer skin 32 which is positioned laterally with respect to the main flow direction 38.

In FIG. 25, the hand-held tool 16 is also shown in a machining position. The machining zone 132 is located beneath the hand-held tool 16 again here.

The hinge 128 is now arranged on a side of the discharge opening 120 facing away from the connecting piece 20. The discharge direction 134 thus points again in the direction of the machining zone when the closure means 122 is open. In the variant shown in FIG. 25, the discharge direction 134 is vertically oriented. It thus only has a component 136 that points vertically downwards in the direction of the machining zone 132.

A method for emptying a collecting container 18 of an assembly 14 having a motor-driven hand-held tool 16 and a collecting container 18 can be carried out both with the collecting container 18 according to the variant shown in FIG. 24 and with the collecting container according to the variant shown in FIG. 25.

In an initial state, the collecting container 18 is coupled to the hand-held tool 16 so that a mixture of air and workpiece particles can be fed from the hand-held tool 16 into the collecting container 18. This coupling is maintained throughout the entire method for emptying the collecting container 18.

In a first step, the closure means 122 is unlocked by actuating the locking unit 130.

Subsequently, in the variant according to FIG. 24, the section of the container body 22 of the collecting container 18 which supports the dimensionally stable frame 126 is tipped upwards against gravity relative to the hand-held tool 16 and the closure means 122. As already mentioned, the coupling is maintained between the collecting container 18 and hand-held tool 16.

Now the component 136 of the discharge direction 134 points vertically downwards in the direction of the machining zone 132 such that workpiece particles can be easily removed from the inside of the container body 22.

For this purpose, the assembly 14 made up of the motor-driven hand-held tool 16 and collecting container 18 can, for example, be held by a bucket or another suitable container. It is important that the hand-held tool 16 is held in the same position that it also assumes during use for material processing.

Once a sufficient quantity of workpiece particles has been removed from the inside of the container body 22, the section of the container body 22 which supports the dimensionally stable frame 126 is tipped downwards again in the direction of gravity and the closure means 122 is locked to the frame 126 by means of the locking unit 130.

In the variant according to FIG. 25, the closure means 126 is folded downwards with the help of gravity.

Now the discharge direction 134 points vertically downwards in the direction of the machining zone 132 such that workpiece particles can be easily removed from the inside of the container body 22.

Once a sufficient quantity of workpiece particles has been removed from the inside of the container body 22, the closure means 126 is moved back into its closed position against the force of gravity and locked there to the frame 126 by means of the locking unit 130.

It should be understood again that the statements regarding FIGS. 24 and 25 are not only applicable in connection with the first embodiment of the collecting container 18, but can be combined with all of the aforementioned embodiments.

FIG. 26 shows the collecting container 18 according to the first embodiment shown in FIGS. 3 and 4 in another perspective view.

FIG. 26 shows that the outer skin 32 has a light entry section 138, which is translucent. In the exemplary embodiment, the light entry section is translucent, but not transparent.

It is made of a white or light grey textile material that is dimensionally stable. The light entry section 138 thus contributes to a filtering effect of the outer skin 32.

Moreover, light can enter the inside of the container body via the light entry section 138.

In addition, the outer skin 32 has a viewing window section 140.

It is made of an optically transparent, dimensionally stable plastic material. The material can also be referred to as a plastic film.

In the exemplary embodiment, the viewing window section 140 is stitched to the remaining sections of the outer skin 32, i.e. it is connected to the remaining sections of the outer skin 32 via a thread.

It is understood that in other exemplary embodiments, the viewing window section 140 is alternatively or additionally connected to the remaining sections of the outer skin 32 by means of a weld, an adhesive seam or other suitable means.

The viewing window section 140 also has an antistatic section 142, which is designed in this case as an electrically conductive coating. It is understood that the antistatic section can fill the entire surface of the viewing window section 140, but it does not have to.

The antistatic section 142 is further electrically connected to an electrical connection contact 144, which is arranged on the connecting piece 20.

Alternatively, the antistatic section 142 can comprise a material with hydrophilic properties so that electrostatic charge can be dissipated into humid ambient air by means of this material. In other words, when using a hydrophilic material, potential equalisation can take place between the antistatic section and the humidity of the ambient air.

The electrical connection contact 144 is designed to enable electrical potential equalisation between the antistatic section 142 and the hand-held tool 16.

Electrostatic charge of the viewing window section 140 is reliably prevented in this way or at least reduced to the extent that the function of the viewing window section 140 is not restricted.

In the present exemplary embodiment, both the viewing window section 140 and the light entry section 138 are also arranged on an outer skin surface of the outer skin 32 which is positioned laterally with respect to the main flow direction 38.

The light entry section 138 is formed on a first outer skin surface 146 of the outer skin 32 and the viewing window section 140 on a second outer skin surface 148 of the outer skin 32.

The first outer skin surface 146 and second outer skin surface 148 adjoin one another at an outer skin edge 150.

The light entry section 148 and viewing window section 140 thus delimit a light-transmitting zone 152, which extends inside the container body 22.

The light-transmitting zone 152 comprises at least one line-of-sight axis 154, which connects at least one point of the light entry section 138 to at least one point of the viewing window section 140 in a straight line.

Light can therefore enter the inside of the container body 22 through the light entry section 138. This enables a user of the collecting container 18 to visually detect a fill level of the collecting container 18 with a high degree of precision through the viewing window section 140.

The viewing window section 140 is optionally provided with a fill level scale 156 for this purpose.

It is understood that the same effects and advantages can also be achieved if the light entry section 138 and viewing window section 140 are formed on outer skin surfaces of the outer skin 32 opposite one another at least in sections. This configuration also results in a straight line-of-sight axis, which connects at least one point of the light entry section 138 to at least one point of the viewing window section 140.

FIG. 27 shows another variant of the collecting container 18 according to the first embodiment shown in FIGS. 3 and 4.

In this variant, the closure means 122 designed as a cover 124 is made of a transparent, dimensionally stable plastic material. The cover 124 thus comprises the light entry section 138.

The light entry section 138 and connecting piece 20 are thus arranged on the same outer skin surface.

The viewing window section 140 is implemented in the same way as in the embodiment according to FIG. 26.

Since both the light entry section 138 and the viewing window section 140 are made of a transparent material in the variant shown in FIG. 27, the function of light entry section 138 and viewing window section 140 can also be reversed. In this context, the cover 124 comprises the viewing window section 140.

It should be understood again that the statements regarding FIGS. 26 and 27 are not only applicable in connection with the first embodiment of the collecting container 18, but can be combined with all of the aforementioned embodiments.

### REFERENCE LIST

10 hand-held tool system
12 storage container
14 assembly
16 motor-driven hand-held tool
18 collecting container
20 connecting piece
21 inlet opening
22 container body
24 free end of the connecting piece
26 support structure
28 strut
30 joint
31 folding mechanism
32 outer skin
34 covering
36 main extension of the container body
38 main flow direction
40 central axis of the connecting piece
42 height of the container body in the transport position
44 support plate of the hand-held tool
46 height of the hand-held tool
48 length of the container body in the transport position
50 longitudinal direction of the hand-held tool
52 length of the support plate
54 width protrusion of the container body in the transport position
56 width of the support plate
58 elastically deformable outer skin section
60 cross frame
62 serrated section of the outer skin
64a serrated strut
64b serrated strut
66a exemplary perimeter of the container body
66b exemplary perimeter of the container body
66c exemplary perimeter of the container body
68 dimensionally stable section of the outer skin
70 outer perimeter of the connecting piece
72 bearing block
74 connector cover
76 axis of rotation
78 longitudinal extension direction of the connecting piece
80 sealing section on the connecting piece side
82 inner perimeter of the connecting piece
84 sealing section on the hand-held tool side
86 sealing section of the cover side
88 sealing element
90 sealing element
92 spring device
94 closure section
96 actuation section
98 actuation surface
100 obtuse angle
102 retaining rib
104 mounting slope
106 recess
108 outlet
110 outer perimeter of the outlet
112 retaining bead
114 mounting slope
116 contact area
118 angle
120 discharge opening
122 closure means
124 cover
126 dimensionally stable frame
128 hinge
130 locking unit
130a first actuation surface
130b second actuation surface
132 machining zone
134 discharge direction
136 vertical extension component of the discharge direction
138 light entry section
140 viewing window section
142 antistatic section
144 electrical connection contact
146 first outer skin surface
148 second outer skin surface
150 outer skin edge
152 light-transmitting zone
154 line-of-sight axis
156 fill level scale
Lmax first outer skin longitudinal dimension
V1 first volume
V2 second volume
N1 notional zero line of the serrated strut 64a
N2 notional zero line of the serrated strut 64a

1. A collecting container for workpiece particles, for coupling to a motor-driven hand-held tool, having a container body, which is delimited by an outer skin,
wherein the container body comprises a folding mechanism so that the container body is configured to selectively assume a work position, in which the outer skin encloses a first volume (V1), and selectively assume a transport position, in which the outer skin encloses a second volume (V2), which is smaller than the first volume (V1), and
wherein a first outer skin longitudinal dimension (Lmax) has a greatest length in comparison to the remaining outer skin longitudinal dimensions in the work position, and the first outer skin longitudinal dimension (Lmax) defines a greatest length of the container body in the transport position.

2. The collecting container according to claim 1, wherein the first outer skin longitudinal dimension (Lmax) defines a greatest overall dimension of the container body in the transport position.

3. The collecting container according to claim 1, wherein the container body (22) has a length, a width and a height in the work position, wherein the length, the width and the height are outer skin longitudinal dimensions and wherein the greatest outer skin longitudinal dimension of length, width and height is the first outer skin longitudinal dimension (Lmax).

4. The collecting container according to claim 1, wherein container body comprises a support structure formed from struts hingedly connected to one another and the outer skin is formed by a covering surrounding the support structure.

5. The collecting container according to claim 4, wherein at least two struts are C-shaped at least in sections and hingedly connected to one another or wherein the struts form at least two strut assemblies which are respectively C-shaped at least in sections so that the at least two struts which are C-shaped at least in sections or the two strut assemblies which are C-shaped at least in sections are configured to be rotated relative to one another in a fan-like manner, or
wherein the struts form a cross frame, or
wherein the support structure is polygonal in a lateral view in relation to a main flow direction.

6. (canceled)

7. (canceled)

8. (canceled)

9. (canceled)

10. (canceled)

11. (canceled)

12. The collecting container according to claim 1, wherein at least one outer skin section is folded into an inside of the container body in the transport position.

13. The collecting container according to claim 1, wherein the container body extends along a main flow direction in the work position.

14. The collecting container according to claim 13, wherein the container body extends transverse to the main flow direction in the transport position.

15. The collecting container according to claim 1, wherein the outer skin has a corrugated or serrated outer skin section at least in the work position.

16. The collecting container according to claim 15, wherein the corrugated or serrated outer skin section is formed by at least one corrugated or serrated strut

17. The collecting container according to claim 1, wherein, in the work position, when viewed along a main flow direction, a perimeter of the container body is either consistent or changes linearly along the main flow direction, or
wherein, in the work position, when viewed transverse to the main flow direction, a perimeter of the container body is either consistent or changes linearly transverse to the main flow direction.

18. The collecting container according to claim 16, wherein at least two corrugated or serrated struts run along the main flow direction and each perimeter extends over a corrugated peak or a serrated peak of one of the struts and through a corrugated trough or a serrated trough of the other strut.

19. The collecting container according to claim 1, wherein the outer skin has at least one elastically deformable outer skin section.

20. The collecting container according to claim 19, wherein the collecting container is configured to be moved from the transport position to the work position via an intermediate position and vice versa, wherein the elastically deformable outer skin section is stretched to the maximum in the intermediate position.

21. (canceled)

22. (canceled)

23. (canceled)

24. An assembly, comprising:
a motor-driven hand-held tool, and
a collecting container according to claim 1, wherein the collecting container is fluidically coupled to the hand-held tool so that a mixture of air and workpiece particles is configured to be fed from the hand-held tool into the collecting container.

25. The assembly according to claim 24, wherein a main extension of the container body is oriented transverse to the main flow direction in the transport position.

26. The assembly according to claim 24, wherein, in the transport position, the container body does not exceed a height of the hand-held tool defined perpendicular to a support plate of the hand-held tool.

27. The assembly according to claim 24, wherein a length of the container body along a longitudinal direction of the hand-held tool in the transport position is no more than 50% of a length of the support plate.

28. The assembly according to claim 24, wherein a width protrusion of the container body beyond a width of the support plate of the hand-held tool in the transport position is no more than 40% of the width of the support plate.

29. A Hand-held tool system having an assembly according to claim 24 and a storage container, wherein the assembly is arranged inside the storage container.

30. (canceled)
